(19) United States
(12) Patent Application Publication
(10) Pub. No.: US 2016/0062885 A1
(43) Pub. Date: Mar. 3, 2016

(54) GARBAGE COLLECTION METHOD FOR NONVOLATILE MEMORY DEVICE

(71) Applicant: SAMSUNG ELECTRONICS CO., LTD., Suwon-Si (KR)

(72) Inventor: IN SIK RYU, YONGIN-SI (KR)

(21) Appl. No.: 14/732,876

(22) Filed: Jun. 8, 2015

(30) Foreign Application Priority Data
Sep. 2, 2014 (KR) 10-2014-0116377

(51) Int. Cl. G06F 12/02

(52) U.S. Cl. CPC G06F 12/0253; G06F 12/0246; G06F 2212/7201; G06F 2212/7205

(57) ABSTRACT

A garbage collection method for a nonvolatile memory includes performing an urgent garbage collection operation by coping at least one page of a first logical area to a free block of a second logical area and remapping a page of the second logical area to the first logical area in response to a remapping command received from a host.

### CROSS-REFERENCE TO RELATED APPLICATION

This application claims the benefit of Korean Patent Application No. 10-2014-0116377 filed on Sep. 2, 2014, the subject matter of which is hereby incorporated by reference.

### BACKGROUND

The inventive concept relates generally to methods of managing memory systems including a nonvolatile memory device. More particularly, the inventive concept relates to garbage collection methods that may be used to manage memory space provided by a nonvolatile memory device.

There are many different kinds of nonvolatile memory, each capable of retaining stored data when applied power is interrupted. Due to the data access characteristics of most nonvolatile memory devices, incoming “write data” (e.g., data received by the nonvolatile memory device in relation to a write (or program) operation, along with a corresponding write address) will be written to the “free area” of the memory space provided by the nonvolatile memory device. In this context, the term “free area” refers to memory locations provided by the nonvolatile memory device that do not currently store data, and memory locations provided by the nonvolatile memory device currently storing data may be referred to as the “used area”.

Thus, regardless of the write address provided with write data in relation to a write command, the nonvolatile memory device will usually write the write data in a free area, as opposed to overwriting some existing data currently stored in a used area of the nonvolatile memory device. Accordingly, it is necessary to provide a mapping function of some sort to effectively correlate, for example, a logical write address received with the write data by the nonvolatile memory device with a corresponding physical address of the nonvolatile memory device at which the write data is actually written. As data is continuously written and rewritten in the nonvolatile memory device, it becomes necessary to efficiently manage the memory space provided by the nonvolatile memory device. That is, memory space allocated to invalid data must be recycled to provide new data storage capacity.

### SUMMARY

Embodiments of the inventive concept provide so-called garbage collection methods that may be used to allocate, de-allocate and/or re-allocate memory space provided by a nonvolatile memory device. For example, certain embodiments of the inventive concept provide a method of efficiently performing garbage collection on the memory space provided by a nonvolatile memory device included in a memory system including a memory controller.

According to an aspect of the inventive concept, there is provided a garbage collection method for a nonvolatile memory device including a nonvolatile memory area, wherein the nonvolatile memory area is mapped to a first logical area accessed based on a first logical address and a second logical area accessed based on a second logical address, and the first logical address is converted by a host into the second logical address. The garbage collection method including; performing an urgent garbage collection operation by copying at least one page of the first logical area to a free block of the second logical area, and remapping a page of the second logical area to the first logical area according to an entry that accompanies a remapping command received from the host and includes the first logical address and second logical address.

According to another aspect of the inventive concept, there is provided a memory system including; a nonvolatile memory device including a nonvolatile memory area mapped to a first logical area accessed by a first logical address and a second logical area accessed by a second logical address, wherein the first logical address is converted by a host into the second logical address, and a controller including a mapping table and configured to change an entry included in the mapping table in response to a remapping command received from the host to remap a page of the second logical area to the first logical area, wherein the controller copies at least one page of the first logical area to a free block of the second logical area to perform an urgent garbage collection operation.

According to another aspect of the inventive concept, there is provided a memory system including; a garbage collection method for a nonvolatile memory device in a memory system including a memory controller, the memory system being operatively connected to a host, wherein a nonvolatile memory area of the nonvolatile memory device is mapped to a first logical area accessed based on a first logical address and a second logical area accessed based on a second logical address. Here, the garbage collection method includes; determining to perform an urgent garbage collection operation, executing the urgent garbage collection operation by copying a page of the first logical area to a free block of the second logical area, and remapping a page of the second logical area to the first logical area according to an entry accompanying a remapping command received from the host and including the first logical address and second logical address.

### BRIEF DESCRIPTION OF THE DRAWINGS

Certain embodiments of the inventive concept are described hereafter with reference to the accompanying drawings in which:

FIG. 1 is a general flowchart summarizing a garbage collection method for a nonvolatile memory device according to an embodiment of the inventive concept;

FIG. 2 is a block diagram illustrating a memory system and a host according to an embodiment of the inventive concept;

FIG. 3 is a conceptual diagram illustrating a case in which the nonvolatile memory area of FIG. 2 is mapped to first and second logical areas according to an embodiment of the inventive concept;

FIG. 4 is a conceptual diagram illustrating various operations executed by the memory system of FIG. 2 according to an embodiment of the inventive concept;

FIGS. 5 and 6 are respective block diagrams illustrating memory systems including a memory controller according to embodiments of the inventive concept;

FIGS. 7 and 8 are respective flowcharts summarizing various operations by the host of FIG. 2 according to an embodiments of the inventive concept;

FIGS. 9, 10 and 11 are respective flowcharts summarizing various operations by the memory controller of FIG. 2 according to embodiments of the inventive concept;

FIG. 12 is a block diagram illustrating a sold-state drive (SSD) that may incorporate a memory system according to an embodiment of the inventive concept;

FIG. 13 is a block diagram illustrating an embedded multimedia card (eMMC) that may incorporate a memory system according to an embodiment of the inventive concept;

FIG. 14 is a block diagram illustrating a universal flash storage (UFS) system that may incorporate a memory system according to an embodiment of the inventive concept; and

FIG. 15 is a block diagram illustrating a computing system that may incorporate a memory system according to an embodiment of the inventive concept.

### DETAILED DESCRIPTION

Embodiments of the inventive concept will now be described in some additional detail. The inventive concept may, however, be embodied in many different forms and should not be construed as limited to only the illustrated embodiments. Rather, these embodiments are provided so that this disclosure is thorough and complete and fully conveys the scope of the inventive concept to one of ordinary skill in the art. Throughout the written description and drawings, like reference numbers and labels are used to denote like or similar elements.

The terminology used herein is for the purpose of describing particular embodiments only and is not intended to be limiting of the inventive concept. As used herein, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless explicitly so defined herein.

As used herein, the term “and/or” includes any and all combinations of one or more of the associated listed items. Expressions such as “at least one of,” when preceding a list of elements, modify the entire list of elements and do not modify the individual elements of the list.

Due to the data access characteristics of a “nonvolatile memory area” (i.e., an area of a nonvolatile memory device providing the memory cells and at least some of the related peripheral circuitry required to write, read and/or erase data store in the memory cells), when a write command is received along with a write address and write data, the incoming write data will be written in a free area of the nonvolatile memory area. This is done rather than over-writing or changing the data stored in the used area of the nonvolatile memory area. In order to systematically implement this approach, write operations must be executed in such a manner that memory space provided by the nonvolatile memory area is effectively managed. This is most usually accomplished by resort to address translation or address conversion, wherein a logical write address received with the write data is converted into a corresponding physical address actually used to access the nonvolatile memory area.

In the context of the inventive concept, a nonvolatile memory device may configured from one or more of a NAND flash memory, a vertical NAND (VNAND) memory, a NOR flash memory, a resistive random access memory (RRAM), a phase-change RAM (PRAM), a magneto-resistive RAM (MRAM), a ferroelectric random access memory (FRAM), or a spin transfer torque RAM (STT-RAM). The nonvolatile memory device may have a three-dimensional (3D) memory array structure, and embodiments of the inventive concept may be applied not only to a flash memory in which a charge storage layer includes a conductive floating gate, but also to a charge-trap flash (CTF) device in which a charge storage layer includes an insulating layer). For brevity of description, the inventive concept will be described by way of examples that assume the use of a NAND flash memory, but it will be understood that the inventive concept is not limited thereto.

In this regard, flash memory does not support an overwrite operation due to the particular, physical characteristics of flash memory cells. Thus, when a memory system including a flash memory receives a write command and executes a corresponding write operation, the write data associated with the write command is written to a free area of the flash memory rather than first erasing some used area, and then programming the write data to the erased area. The operation of writing the write data in the free area may be performed under the control of a controller (or memory controller) configured to manage the flash memory. For example, the operation of writing the new write data in the free area may be substantially controlled by operation of specialty software commonly referred to as a “flash translation layer”, or FTL. In such embodiments, the FTL may further facilitate the use of one or more error detection and/or correction operations using error correction code (ECC) associated with the write data.

As a by-product of this approach to writing data in a flash memory, a certain amount of “invalid data” will accumulate in some of the used areas of the nonvolatile memory area of the nonvolatile memory device. A class of operations that recycle used area(s) storing invalid data (i.e., operations that convert used area(s) to free area(s) capable of storing incoming write data) is commonly referred to as garbage collection operations. For example, in a flash memory the corresponding flash memory area usually includes a plurality of blocks, where each block includes a plurality of pages. Further, in a flash memory, data is written (or programmed) on a page-by-page basis (i.e., according to page units), but erased on a block-by-block basis (i.e., according to block units). Thus, in a flash memory, an executed garbage collection operation will typically generate a “free block” including a plurality of “free pages” ready to receive and store incoming write data.

In the flash memory, the garbage collection operation may include copying, for example, valid pages (pages in which valid data is stored) included in at least two source blocks to a destination block that is a free block, and allocating the source blocks as free blocks (i.e., removing the source blocks). Also, the garbage collection operation may include copying a valid page from a source block to a destination block including a free page (i.e., a page in which data is not stored), and allocating the source block as a free block.

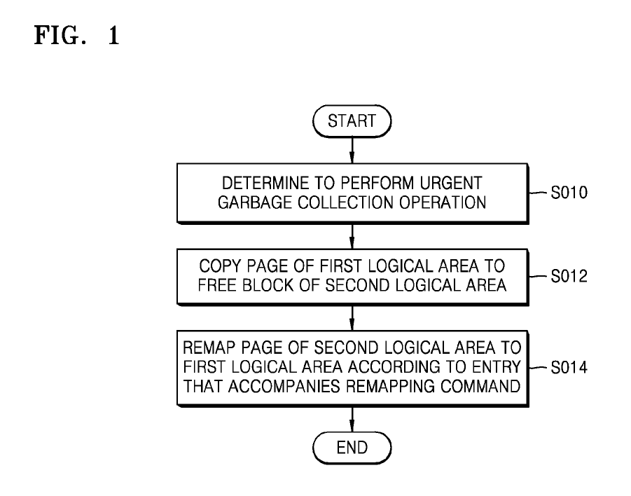

Figure (FIG. 1) is a flowchart summarizing a garbage collection method for a nonvolatile memory device according to certain embodiments of the inventive concept. Here, it is assumed that a nonvolatile memory area included in the nonvolatile memory device is mapped according to a “first logical area” accessed on the basis of a “first logical address” and a “second logical area” accessed on the basis of a “second logical address”, where the second logical address is a logical address into which the first logical address is converted by a host. Further assuming that the host randomly writes data or writes “journal data”, the second logical address may be an address communicated by the host to a memory system including the nonvolatile memory device. With these assumptions, the host may further communicate a “remapping command” to the nonvolatile memory system, such that the nonvolatile memory system remaps at least a portion of the second logical area to the first logical area.

In the garbage collection method summarized in FIG. 1, a determination is made that an “urgent garbage collection operation” is required (S010). The urgent garbage collection operation differs from a “normal garbage collection operation” in that the normal garbage collection operation is performed during idle periods of the memory system operation. In contrast, an urgent garbage collection operation is performed in response to an ongoing, or next-to-be-executed write operation when the current number of free block(s) is insufficient to receive the write data associated with the ongoing or next-to-be-executed write operation. Thus, in a memory system operating in accordance with an embodiment of the inventive concept, a normal garbage collection operation may be performed during an idle period in which the memory system is not occupied with the execution of data access operation(s) (e.g., read, write and/or erase operations) in response to a corresponding command from a host. By performing normal garbage collection operations during idle periods, the number of free blocks available in a nonvolatile memory area of the nonvolatile memory device may be routinely increased.

However, a relatively long stream of write operations without intervening idle period may result in an insufficient number of free blocks for a next write operation. Here, in the context of this description, the term “next write operation” is used to denote a particular write operation, the execution of which is not possible due to the insufficient number of free blocks. Accordingly, the receipt of a “next write command” associated with the next write operation will trigger the execution of an urgent garbage collection operation capable of immediately providing one or more additional free blocks in a flash memory, such that the execution of the next write operation is made possible.

Unlike the garbage collection operation performed in the idle period, the urgent garbage collection operation will be preferentially executed to make provision for the execution of the next (and possibly additional, subsequent) write commands. Thus, the memory system will not attempt to execution the next write operation (and/or will not respond to certain other commands received from the host) until the urgent garbage collection operation has been completed. In certain embodiments of the inventive concept, the indication and execution of an urgent garbage collection operation may cause a “long busy” situation, wherein a time duration during which the memory system fails to respond to one or more commands from the host may exceed a predetermined time duration limit

This result is significant to the overall performance of the memory system. That is, execution of the urgent garbage collection operation required to generated additional free blocks may be relatively long. And the longer the execution period for urgent garbage collection operation, the less efficient the overall memory system performance becomes. Accordingly, embodiments of the inventive concept provide urgent garbage collection operations that are capable of being more quickly performed to improve memory system performance. In this regard and in view of the foregoing assumptions related to step S010 of FIG. 1, when a number of free blocks available in the nonvolatile memory area mapped to the first logical area proves insufficient, a determination is made that execution of an urgent garbage collection operation is required.

When this determination is made (S010), an urgent garbage collection method according to an embodiment may include copying a page from the first logical area to a free block of the second logical area (S012). However, when the urgent garbage collection operation is performed in the first logical area having insufficient free blocks, it may take a relatively long period of time to select the particular destination block and/or source block. Therefore, according to embodiments of the inventive concept, when a page included in the source block of the first logical area is copied to a free block of the second logical area and the source block is allocated as the free block, the time required to select the destination block and/or source block is reduced. Further, during certain urgent garbage collection methods according to the inventive concept, one or more valid pages included in the source block may be copied to the destination block.

Referring again to FIG. 1, the urgent garbage collection method includes remapping a page of the second logical area to the first logical area according to an entry that accompanies a remapping command (S014). That is, the memory system receives a remapping command from the host, where the remapping command is accompanied by at least one entry. The entry accompanying the remapping command will include a first logical address paired with a second logical address mapped by the host. The memory system (or controller included in the memory system) may remap a page corresponding to the second logical address to the first logical area corresponding to the first logical address. Thus, the page of the second logical area, which is copied due to the urgent garbage collection operation, may be remapped to the first logical area.

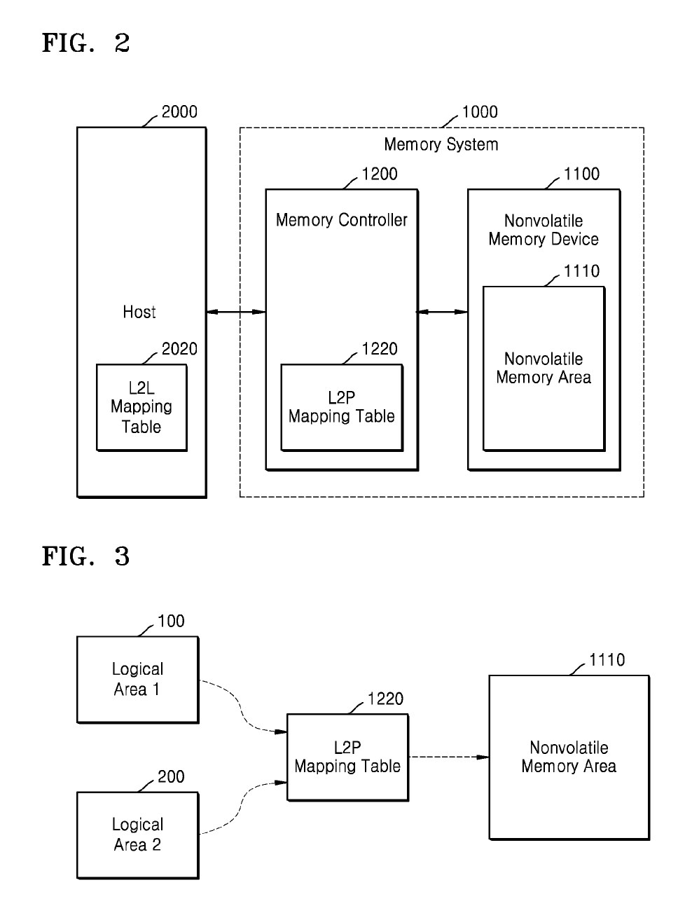

FIG. 2 is a block diagram of a memory system 1000 operatively connected to a host 2000 according to an embodiment of the inventive concept. The memory system 1000 receives command(s) provided by the host 2000, and performs corresponding operation(s) (e.g., read and/or write operations).

The memory system 1000 of FIG. 2 includes a nonvolatile memory device 1100 and a memory controller 1200. The nonvolatile memory device 1100 includes a nonvolatile memory area 1110 including memory cells capable of storing data even power is interrupted. The nonvolatile memory device 1100 is operatively connected to the memory controller 1200, such that the nonvolatile memory device 1100 may write data in the nonvolatile memory area 1110, read data from the nonvolatile memory area 1110, and/or erase data stored in the nonvolatile memory area 1110 under the control of the memory controller 1200. Although FIG. 2 illustrates a case in which the nonvolatile memory device 1100 includes only the nonvolatile memory area 1110, the inventive concept is not limited thereto, and the nonvolatile memory device 1100 will include conventionally understood circuits and data buffers necessary to access the nonvolatile memory area 1110.

With this configuration, the memory controller 1200 may control the nonvolatile memory device 1100 in response to a command received from the host 2000, and perform certain internal operations (e.g., garbage collection operations, ECC operations, etc.) necessary to the proper performance of the memory system 1000. The memory controller 1200 of FIG. 2 includes a logical-to-physical address (L2P) mapping table 1220 that includes entries pairing (i.e., correlating) logical addresses received from the host 2000 with corresponding physical addresses communicated to the nonvolatile memory device 1100. The memory controller 1200 may add an entry to the L2P mapping table 1220 or change an entry to manage the memory space provide by the nonvolatile memory device 1100. According to certain embodiments of the inventive concept, the memory controller 1200 may perform various garbage collection operations, such as the one described in relation to FIG. 1, using the L2P mapping table 1220.

As shown in FIG. 2, the host 2000 may include a logical-to-logical address (L2L) mapping table 2020. The L2L mapping table 2020 includes entries pairing a first logical address with a corresponding second logical address. Here, the host 2000 may sort the entries included in the L2L mapping table 2020 according to values of the first logical address. Further, the host 2000 will perform a data write operation or a data read operation based on the first logical address, but perform a random write or journal write operation based on the second logical address. For example, the host 2000 may include a file system for the memory system 1000. When transactions (e.g., updating or changing of files) occur, the host 2000 may generate journal data and communicate the journal data along with a write command to the memory system 1000. According to an embodiment, the host 2000 may communicate a write command for writing journal data together with the second logical address into which the first logical address is converted, using the L2L mapping table 2020. Subsequently, the host 2000 may communicate a remapping command to the memory system 1000. Thus, the memory system 1000 may omit copying the journal data. In addition, when a random write operation occurs in response to a plurality of write requests having discontinuous first logical addresses, the host 2000 may communicate a write command to the memory system 1000 together with the second logical address into which the first logical address is converted, using the L2L mapping table 2020.

According to an embodiment, the host 2000 may communicate a remapping command to the memory system 1000. The remapping command may be accompanied with at least one entry included in the L2L mapping table 2020, and the entry communicated to the memory system 1000 with the remapping command may be deleted from the L2L mapping table 2020. For example, when a check point occurs or data of a main memory included in the host 2000 is flushed, the host 2000 may communicate the remap command to the memory system 1000. In addition, after the host 2000 communicates a write command based on the second logical address during a random write operation, the host 2000 may communicate the remapping command. Also, when the number of entries included in the L2L mapping table 2020 is greater than or equal to a predetermined number, the host 2000 may communicate the remapping command. The memory controller 1200 of the memory system 1000 may receive the remapping command, change a logical address of the entry included in the L2P mapping table 1220, and remap a page of the second logical area to the first logical area.

According to an embodiment, during the urgent garbage collection operation, the memory controller 1200 may transit an entry including the first logical address for the page copied from the first logical area to the host 2000, and the host 2000 may update the L2L mapping table 2020 based on the entry received from the memory system 1000 (i.e., memory controller 1200). That is, the memory controller 1200 may communicate updated information to the host 2000 regarding the page mapped from the first logical area to the second logical area due to execution of an urgent garbage collection operation internally performed in the memory system 1000. Thus, when the host 2000 communicates the remapping command to the memory system 1000, a page copied due to execution of an urgent garbage collection operation, along (possibly) with other pages of the second logical area, may be remapped to the first logical area.

In certain embodiments of the inventive concept, the nonvolatile memory area 1110 may include a three dimensional (3D) memory array. The 3D memory array may be monolithically formed in one or more physical levels of arrays of memory cells having an active area disposed above a silicon substrate and circuitry associated with the operation of those memory cells, whether such associated circuitry is above or within such substrate. Here, the term “monolithic” means that layers of each level of the array are directly deposited on the layers of each underlying level of the array. The 3D memory array may include vertical NAND strings that are vertically oriented such that at least one memory cell is located over another memory cell, and the at least one memory cell may comprise a charge trap layer.

Examples of 3D memory arrays suitable for incorporation within certain embodiments of the inventive concept are presented in U.S. Pat. Nos. 7,679,133; 8,553,466; 8,654,587 and 8,559,235, as well as published U.S. Patent Application 2011/0233648, the collective subject matter of which is hereby incorporated by reference.

FIG. 3 is a block diagram illustrating a case in which the nonvolatile memory area 1110 of FIG. 2 is mapped to the first and second logical areas 100 and 200 according to an embodiment of the inventive concept. Referring to FIGS. 2 and 3, the nonvolatile memory area 1110 included in the nonvolatile memory device 1100 is a physical memory area mapped to a first logical area 100 accessed due to the first logical address and a second logical area 200 accessed due to a second logical address. That is, a first part of the nonvolatile memory area 1110 is mapped to the first logical area 100, and different second part of the nonvolatile memory area 1110 is mapped to the second logical area 200. The L2P mapping table 1220 included in the memory controller 1200 may include entries associated with the first or second logical address and a physical address. Thus, the L2P mapping table 1220 may be used to store mapping information between the first and second logical areas 100 and 200 and the nonvolatile memory area 1110.

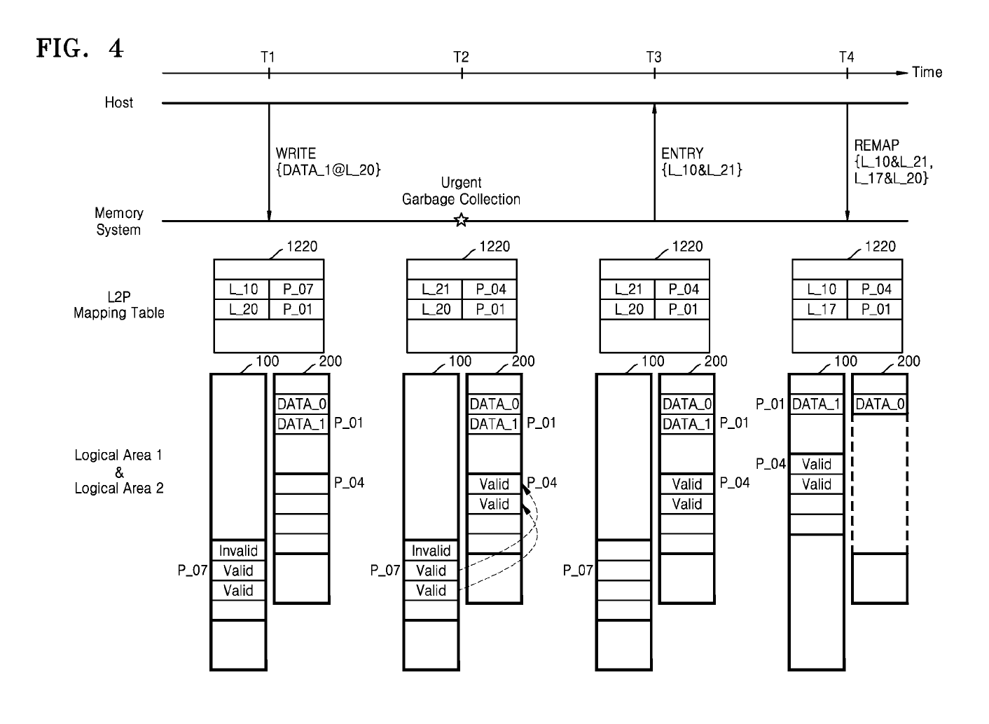

FIG. 4 is a conceptual diagram illustrating various operations executed by the host 2000 and memory system 1000 of FIG. 2. In FIG. 4, it is assumed that a time passes from left to right in the illustration, and it is further assumed that one block includes only four pages, for the sake of clarity.

With reference to FIGS. 2 and 4, at time T1, the host 2000 communicates a write command to the memory system 1000. The write command may be accompanied by a second logical address “L_{—}20” and first data DATA_{—}1. In response to the received write command, the memory controller 1200 of the memory system 1000 may write first data DATA_{—}1 in a page corresponding to the second logical address “L_{—}20” in the second logical area 200, and add an entry including the second logical address “L_{—}20” and a physical address “P_{—}01” of the page in which the first data DATA_{—}1 is written, to the L2P mapping table 1220.

At time T2, an urgent garbage collection operation is performed in the memory system 1000. That is, the memory controller 1200 recognizes that a current number of free blocks included in the first logical area 100 is insufficient (i.e., falls below an established threshold or is inadequate for a next write operation in a pipeline of operations), and therefore determines to perform an urgent garbage collection operation. As shown in FIG. 4, the memory controller 1200 may copy two valid pages included in a block (i.e., source block) including the page corresponding to the physical address “P_{—}07” to a free block of the second logical area 200, that is, a block (i.e., destination block) including a page corresponding to a physical address “P_{—}04”.

The memory controller 1200 may then update the L2P mapping table 1220 to include an entry including a second logical address “L_{—}21” and the physical address “P_{—}04” of the coped valid page. As shown in FIG. 4, the memory controller 1200 may change the entry of the existing valid page to update the L2P mapping table 1220. Alternately, the memory controller 1200 may add the entry including the second logical address “L_{—}21” and the physical address “P_{—}04” of the copied valid page to update the L2P mapping table 1220.

As shown in FIG. 4, at time T3, the memory system 1000 may communicate an entry including the first logical address and the second logical address to the host 2000. That is, the memory controller 1200 of the memory system 1000 may communicate an entry including the previous first logical address “L_{—}10” and the current second logical address “L_{—}21” of the page copied at the point of time T2, to the host 2000. As shown in FIG. 2, the host 2000 may update the L2L mapping table 2020, that is, add the received entry to the L2L mapping table 2020, according to the entry received from the memory system 1000.

The memory controller 1200 may then erase a block of the first logical area 100 including the valid page copied to the free block of the second logical area 200, that is, a block (i.e., source block) including a page corresponding to a physical address “P_{—}07” and allocate the source block as the free block. FIG. 4 illustrates a case in which the communication of the entry from the memory system 1000 to the host 2000 and the allocation of the source block as the free block occur at time T3, but the inventive concept is not limited thereto. That is, the communication of the entry and allocation of the source block as the free block may occur at different times.

As shown in FIG. 4, the host 2000 may communicate a remapping command to the memory system 1000 at time T4. The host 2000 may accompany the remapping command with at least one entry included in the L2L mapping table 2020 and communicate the at least one entry to the memory system 1000. Here, the host 2000 may accompany the remapping command with entries including the first logical address and the second logical address, and communicate the entries “L_{—}10&L_{—}21” and “L_{—}17&L_{—}20” to the memory system 1000. The memory controller 1200 of the memory system 1000 may update the L2P mapping table 1220 in response to the remapping command and the entries that accompany the remapping command. For example, as shown in FIG. 4, the memory controller 1200 may change second logical addresses included in the entries of the L2P mapping table 1220 into first logical addresses “L_{—}10” and “L_{—}17” included in the entries accompanying the remapping command. Thus, pages corresponding to physical addresses “P_{—}01” and “P_{—}04” included in the second logical area 200 may be remapped to the first logical area 100. Only the L2P mapping table 1220 may be updated in response to the remapping command, thereby preventing the copying of pages.

As described above, the host 2000 may sort a plurality of entries included in the L2L mapping table 2020 according to values of the first logical address, accompany a remapping command with a series of entries in the sorted order, and communicate the entries to the memory system 1000. The memory controller 1200 may sequentially remap pages of the second logical area 200 to the first logical area 100 in the order of a series of entries received from the host 200. Thus, when the memory controller 1200 manages the L2P mapping table 1220 based on the values of the first logical address, the pages may be sequentially remapped according to the values of the first logical address to reduce the number of times the L2P mapping table 1220 is updated.

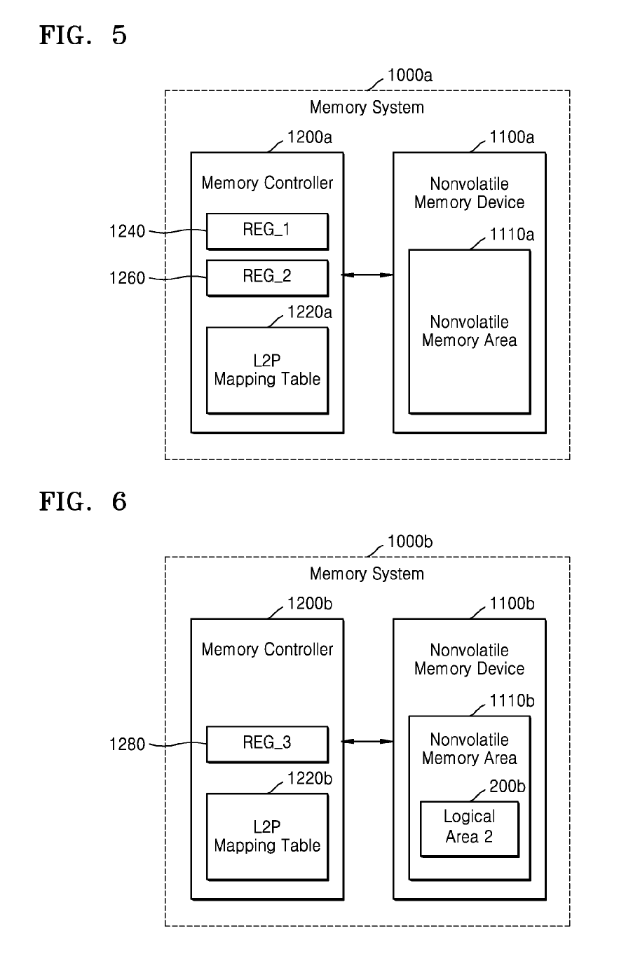

FIG. 5 is a block diagram illustrating a memory system 1000a including a memory controller 1200a according to an embodiment of the inventive concept. As shown in FIG. 5, the memory system 1000a includes a nonvolatile memory device 1100a and a memory controller 1200a connected to the nonvolatile memory device 1100a. The nonvolatile memory device 1100a may include a nonvolatile memory area 1110a, and the memory controller 1200a may include an L2P mapping table 1220a.

According to an embodiment, the memory controller 1200a may include a first register 1240 and a second register 1260. Referring back to FIG. 3, the first register 1240 may store the number of free blocks of the first logical area 100, and the second register 1260 may store the number of free blocks of the second logical area 200. According to an embodiment, the first register 1240 and the second register 1260 may store values in a nonvolatile manner. Alternatively, values respectively stored in the first register 1240 and the second register 1260 by the memory controller 1200a may be periodically stored in an additional nonvolatile storage space.

According to an embodiment, when a value stored in the first register 1240 is less than a predetermined value, the memory controller 1200a may determine to perform an urgent garbage collection operation. That is, when the number of the free blocks of the first logical area 100 is less than a predetermined number, the memory controller 1200a may determine to perform the urgent garbage collection operation. When the first logical area 100 has insufficient free blocks, it may be impossible for the memory system 1000 to execute a next write operation in response to a next write command accompanied with a subsequently expected first logical address. Thus, the memory controller 1200a may determine to perform an urgent garbage collection operation based on the value stored in the first register 1240, and perform the urgent garbage collection operation consistent with an embodiment of the inventive concept.

According to an embodiment, when a value stored in the second register 1260 is less than a predetermined value, the memory controller 1200a may communicate a signal (e.g., a “FULL” signal) to the host 2000. That is, the memory controller 1200a may inform the host 2000 that the number of the free blocks of the second logical area 200 is less than a predetermined number. When the second logical area 200 is short of free blocks, it may be impossible for the memory system 1000 to perform a next write operation in response to a next write command accompanied with a subsequently expected second logical address. Thus, the memory controller 1200a may communicate the “FULL” signal to the host 2000 based on the value stored in the second register 1260 so that the host 2000 may communicate a remapping command in response to the “FULL” signal.

FIG. 6 is a block diagram illustrating a memory system 1000b including a memory controller 1200 according to another embodiment of the inventive concept. As shown in FIG. 6, the memory system 1000b includes a nonvolatile memory device 1100b and a memory controller 1200b connected to the nonvolatile memory device 1100b. The nonvolatile memory device 1100b may include a nonvolatile memory area 1110b, and the memory controller 1200b may include an L2P mapping table 1220a.

As shown in FIG. 6, the memory controller 1200b may include a third register 1280. According to an embodiment, a second logical area 200b may be mapped to a continuous physical area of the nonvolatile memory area 1110b. The continuous physical area may be an area of the nonvolatile memory area 1110b that is accessed due to sequentially increasing or decreasing physical addresses. The third register 1280 may store a start address (i.e., physical address) of the continuous physical area.

According to an embodiment, the memory controller 1200b may access the area (i.e., the continuous physical area) of the nonvolatile memory area 1110b to which the second logical area 200b is mapped, based on the value stored in the third register 1280 and the second logical address received from the host 2000 along with the write command. For example, when the second logical address is an offset to a start address of the second logical area 200b, the memory controller 1200b may access the area of the nonvolatile memory area 1110b to which the second logical area 200b is mapped, based on the sum of the value stored in the third register 1280 and the second logical address.

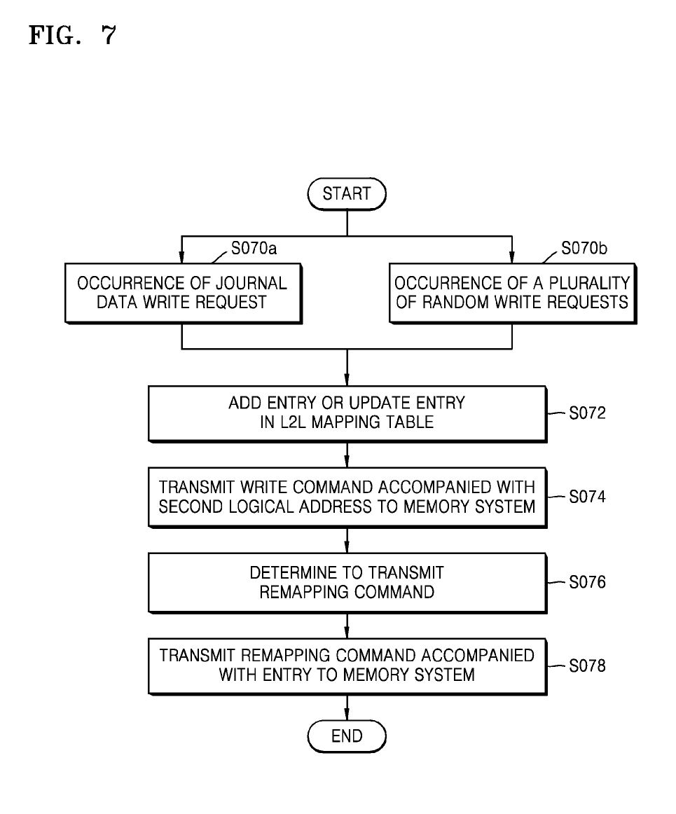

FIG. 7 is a flowchart summarizing an operation of the host 2000 of FIG. 2, according to an embodiment of the inventive concept. Referring to FIGS. 2 and 7, when a journal data write request occurs (S070a) or when a plurality of random write requests occur (S070b), the host 2000 may access a second logical area, as described above. That is, the host 2000 may add an entry including a first logical address accompanying a write request and a new second logical address to an L2L mapping table 2020, or change a second logical address of an entry including a first logical address included in the L2L mapping table 2020 to update the L2L mapping table 2020 (S072). The host 2000 may communicate (e.g., transmit) a write command accompanied with the second logical address used to update the L2L mapping table 2020, to the memory system 1000 (S074).

As described above, when a check point occurs, when data of a main memory is flushed, when a random write operation is completed, or when the L2L mapping table 2020 is short of free entries, the host 2000 may determine to communicate a remapping command (S076). Thus, the host 2000 may communicate a remapping command accompanied with at least one entry included in the L2L mapping table 2020 to the memory system 1000 (S078). The entry communicated to the memory system 1000 is removed from the L2L mapping table 2020.

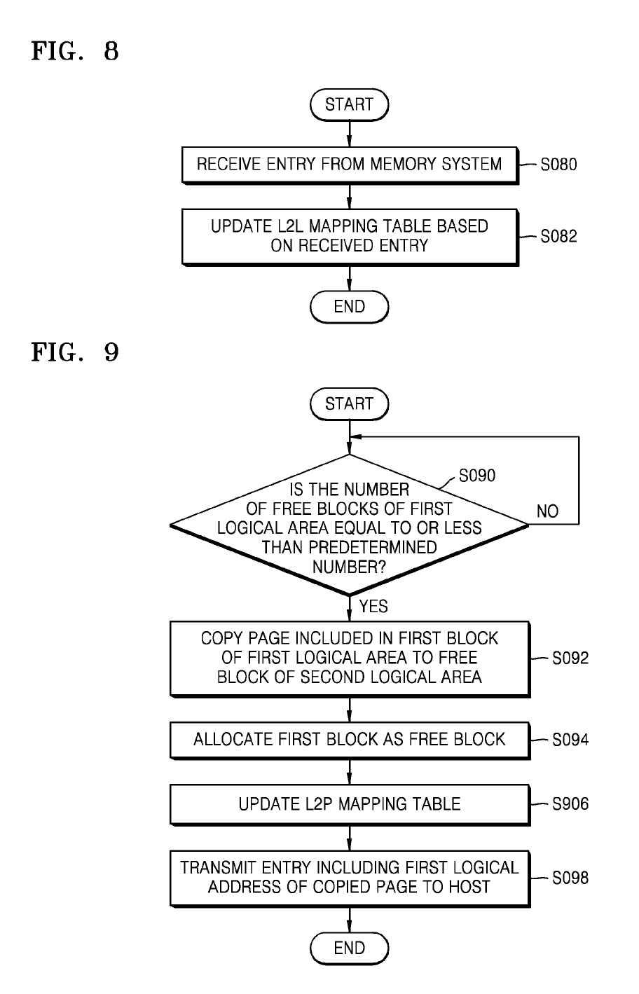

FIG. 8 is a flowchart summarizing an operation of the host 2000 of FIG. 2 according to an embodiment of the inventive concept. Referring to FIGS. 2 and 8, the host 2000 may receive an entry including a first logical address and a second logical address from the memory system 1000 (S080). For example, in the memory system 1000, the memory controller 1200 may perform an urgent garbage collection operation according to an embodiment of the inventive concept, and communicate the entry including the first logical address and the second logical address which is coped to the second logical area 200 to the host 2000.

The host 2000 may update the L2L mapping table 2020 based on the entry received from the memory system 1000 (S082). For example, the host 2000 may add the entry received from the memory system 1000 to the L2L mapping table 2020. The entry added to the L2L mapping table 2020 may accompany a remapping command that will be subsequently communicated by the host 2000 to the memory system 1000.

FIG. 9 is a flowchart summarizing an operation of a memory controller 1200 of FIG. 2 according to an embodiment of the inventive concept. Referring to FIGS. 2, 3, and 9, the memory controller 1200 may determine whether a number of free blocks of the first logical area 100 meets an established limit, i.e., a predetermined number (S090). When the number of the free blocks of the first logical area 100 is less than the predetermined number, the memory controller 1200 may copy a page included in a first block (or source block) of the first logical area 100 to a free block of the second logical area 200 (S092). In this case, the copied page included in the first block may be a valid page in which valid data is stored.

The memory controller 1200 may allocate the first block of the first logical area 100 as a free block (S094). For example, the memory controller 1200 may erase the first block and update the L2P mapping table 1220 to allocate the first block as the free block. The memory controller 1200 may add an entry including a second logical address of a page copied to the second logical area 200 and a physical address to the L2P mapping table 1220 or replace the entry with the existing entry to update the L2P mapping table 1220 (S96). The memory controller 1200 may communicate an entry including the first logical address of the copied page to the host 200 (S098). For example, the memory controller 1200 may communicate the entry including the first logical address and the second logical address of the copied page to the host 2000.

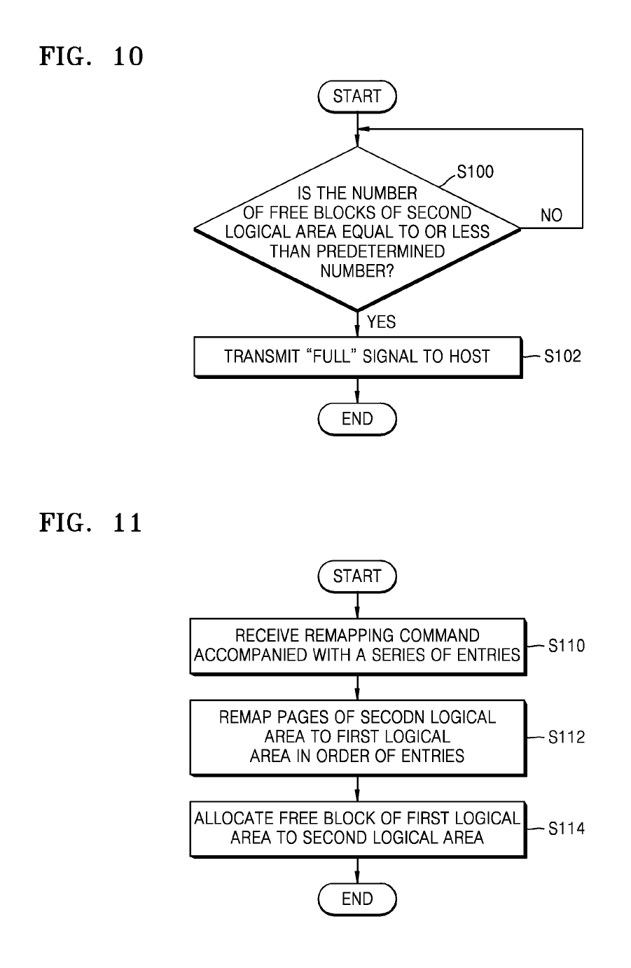

FIG. 10 is a flowchart summarizing an operation of the memory controller 1200 of FIG. 2 according to an embodiment of the inventive concept. Referring to FIGS. 2, 3, and 10, the memory controller 1200 may determine whether a number of free blocks of the second logical area 200 meets an established limit, i.e., a predetermined number (S100). When the number of the free blocks of the second logical area 200 is less than the predetermined number, the memory controller 1200 may communicate a signal (i.e., a “FULL” signal) to the host 2000 (S102). The memory controller 1200 may communicate the “FULL” signal to the host 2000 so that the host 2000 will then communicate a remapping command.

FIG. 11 is a flowchart summarizing an operation of the memory controller 1200 of FIG. 2 according to an embodiment of the inventive concept. Referring to FIGS. 2, 3, and 11, the memory controller 1200 may receive a remapping command accompanied with a series of entries from the host 2000 (S110). As described above, the host 2000 may sort the entries included in the L2L mapping table 2020 according to values of a first logical address accompany a remapping command with the entries in the sorted order, and communicate the remapping command to the memory system 1000.

The memory controller 1200 may remap pages of the second logical area 200 to the first logical area 100 in the order of the series of entries that accompany the remapping command (S112). Thus, when the memory controller 1200 manages the L2P mapping table 1220 based on the value of the first logical address, the pages may be sequentially remapped according to the value of the first logical address to reduce the number of times the L2P mapping table 1220 is updated.

The memory controller 1200 may allocate a free block of the first logical area 100 to the second logical area 200 (S114). When the memory controller 1200 remaps the page of the second logical area 200 to the first logical area 100 in response to the remapping command received from the host 2000, the number pages of the second logical area 200 may be reduced. Thus, to ensure a write command accompanied with a subsequently expected second logical address and a physical area to which the second logical area 200 for an urgent garbage collection operation is mapped, the memory controller 1200 may allocate a free block of the first logical area 100 to the second logical area 200. For example, in the embodiment shown in FIG. 6, the memory controller 1200 may change values stored in the third register 1280 to allocate a plurality of physically continuous free blocks of the first logical area 100 to the second logical area 200.

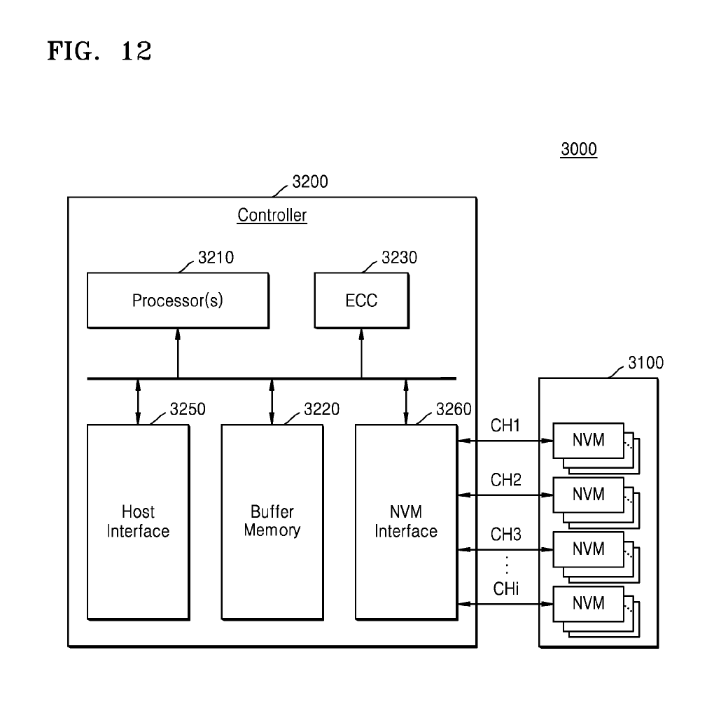

FIG. 12 is a block diagram illustrating a solid-state drive (SSD) 3000 the may incorporate a memory system according to an embodiment of the inventive concept. As shown in FIG. 12, the SSD 3000 includes a plurality of nonvolatile memory devices 3100 and a controller 3200 operatively connected to the nonvolatile memory devices 3100 through a plurality of channels CH1 to CHi. The controller 3200 may perform an operation or garbage collection method according to one of the above-described embodiments. For example, the controller 3200 may perform an urgent collection operation by copying a page of a first logical area to a free block of a second logical area, in the first logical area and the second logical area to which a nonvolatile memory area of the nonvolatile memory devices 3100 is mapped.

As shown in FIG. 12, the controller 3200 may include at least one processor 3210, a buffer memory 3220, an error correction circuit (ECC) 3230, a host interface 3250, and a nonvolatile memory interface 3260, which may be connected to a bus.

The buffer memory 3220 may store data required for an operation of the controller 3200, for example, in the L2P mapping table 1220 of FIG. 2. The ECC 3230 may calculate an error correction code (ECC) value of data received from a host along with a write command, and correct an error in data read from the nonvolatile memory device 3100 based on the ECC value. The host interface 3250 may interface with a host disposed outside the SSD 3000, and the nonvolatile memory interface 3260 may interface with the nonvolatile memory device 3100.

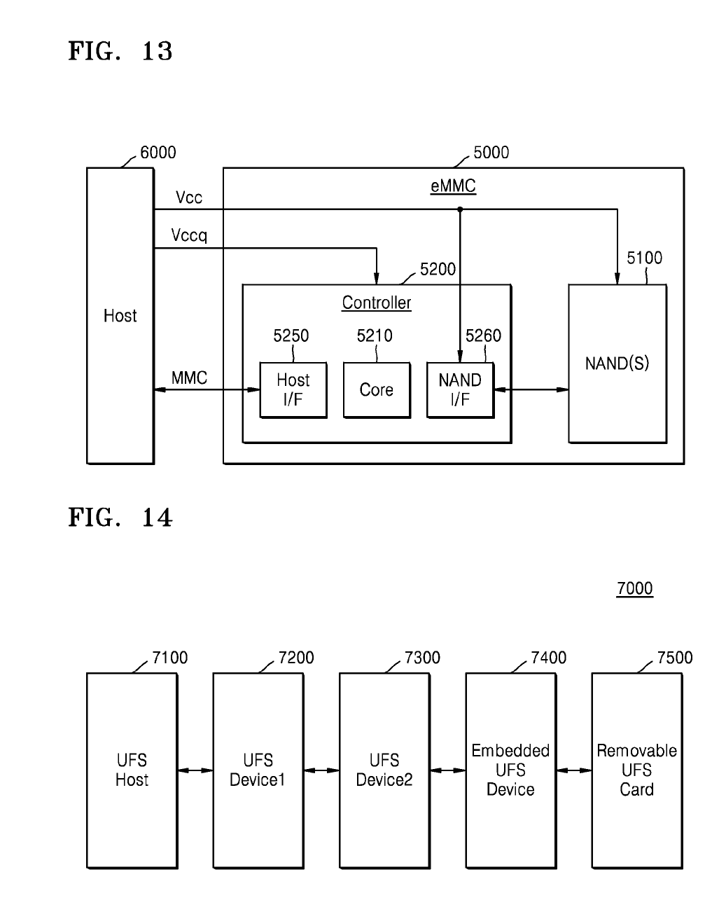

FIG. 13 is a block diagram illustrating an embedded multimedia card (eMMC) (e.g., moviNAND or iNAND 5000) that may incorporate a memory system according to an embodiment of the inventive concept. As shown in FIG. 13, the eMMC 5000 may be connected to a host 6000 through a plurality of lines and include at least one NAND flash memory device 5100 and a controller 5200. The controller 5200 may perform an operation or garbage collection method according to one of the above-described embodiments. For example, the controller 5200 may perform an urgent garbage collection operation by copying a page of a first logical area to a free block of a second logical area, in the first logical area and the second logical area to which a NAND flash memory area of a NAND flash memory device 5100 is mapped.

The controller 5200 may be connected to the NAND flash memory device 5100 and includes a core 5210, a host interface 5250, and a NAND interface 5260. The core 5210 may control general operations of the eMMC 5000. The host interface 5250 may interface with the host 6000, and the NAND interface 5260 may interface with the NAND flash memory device 5100. According to an embodiment, the host interface 5250 may support a serial interface (e.g., ultrahigh-speed-II (UHS-II) or universal flash storage (UFS) interface) or support a parallel interface (e.g., multimedia card (MMC) interface). As shown in FIG. 13, the eMMC 5000 may receive power supply voltages (e.g., Vcc and Vccq) from the host 6000, where the power supply voltages are communicated to the controller 5200 and NAND flash memory device 5100, respectively

FIG. 14 is a block diagram of a UFS system 7000 that may incorporate a memory system according to an embodiment of the inventive concept. As shown in FIG. 14, the UFS system 7000 may include a UFS host 7100, UFS devices 7200 and 7300, an embedded UFS device 7400, and a removable USF card 7500. The UFS host 7100 may be an AP of a mobile device and perform an operation of the host 2000 shown in FIG. 2. The UFS host 7100 and the removable UFS card 7500 may communicate with each other via various card protocols (e.g., USB flash drives (UFDs), MMC, SD (Secure Digital), mini SD, or Micro SD).

The UFS host 7100, the UFS devices 7200 and 7300, the embedded UFS device 7400, and the removable USF card 7500 may communicate with one another according to a UFS protocol. The UFS devices 7200 and 7300, the embedded UFS device 7400, or the removable USF card 7500 may include a memory controller according to an embodiment. For example, the UFS card 7500 may include a memory controller and a flash memory device. In this context, a memory controller may perform an urgent garbage collection operation by copying a page of a first logical area to a free block of a second logical area, in the first logical area and the second logical area to which a flash memory area of the flash memory device is mapped.

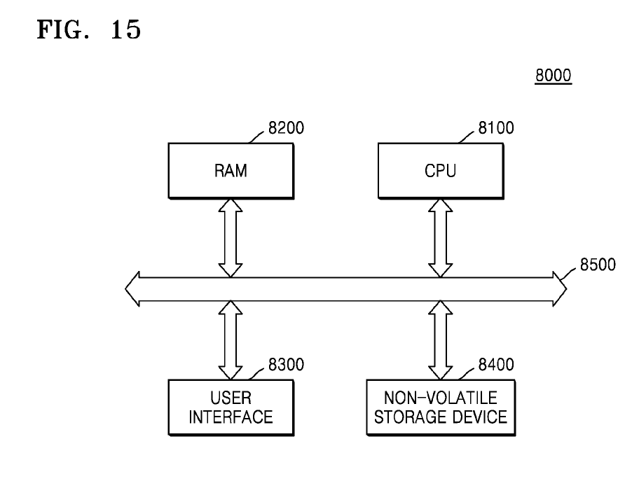

FIG. 15 is a block diagram illustrating a computing system 8000 that may incorporate a nonvolatile storage device 8100 according to an embodiment of the inventive concept. Here, a memory system according to an embodiment may be mounted as a nonvolatile storage device 8400 on the computing system 8000, such as a mobile device or a desktop computer. The memory system mounted as the nonvolatile storage device 8400 may include a memory controller and a nonvolatile memory device according to one of the above-described embodiments. That is, the memory controller may copy a page of a first logical area to a free block of a second logical area in the first logical area and the second logical area to which the nonvolatile memory area of the nonvolatile memory device is mapped, and perform an urgent garbage collection operation.

The computing system 8000 according to an embodiment may include a central processing unit (CPU) 8100, a RAM 8200, a user interface 8300, and a nonvolatile storage device 8400, each of which may be connected to a bus 8500. The CPU 8100 may generally control the computing system 8000. The CPU 8100 may be, for example, an application processor (AP). The RAM 8200 may function as a data memory of the CPU 8100. The RAM 8200 may be integrated with the CPU 8100 and embodied as a single chip by using a system-on-chip (SOC) technique or a package-on-package (POP) technique. The user interface 8300 may receive inputs from a user or output signals to the user via images and/or voices.

While the inventive concept has been particularly shown and described with reference to certain embodiments thereof, it will be understood that various changes in form and details may be made therein without departing from the scope of the following claims.

What is claimed is:

1. A garbage collection method for a nonvolatile memory device including a nonvolatile memory area, wherein the nonvolatile memory area is mapped to a first logical area accessed based on a first logical address and a second logical area accessed based on a second logical address, and the first logical address is converted by a host into the second logical address, the garbage collection method comprising:
performing an urgent garbage collection operation by copying at least one page of the first logical area to a free block of the second logical area; and
remapping a page of the second logical area to the first logical area according to an entry that accompanies a remapping command received from the host and includes the first logical address and second logical address.

2. The method of claim 1, further comprising:
determining to perform the urgent garbage collection operation when a number of free blocks included in the first logical area is less than a predetermined number.

3. The method of claim 1, further comprising:
communicating an entry including a first logical address of the at least one copied page to the host.

4. The method of claim 1, wherein the performing of the urgent garbage collection operation comprises copying a page included in a first block of the first logical area to the free block of the second logical area and allocating the first block as the free block.

5. The method of claim 1, further comprising:
communicating a signal from the nonvolatile memory device to the host indicating that a number of free blocks of the second logical area is less than or equal to a predetermined number.

6. The method of claim 1, wherein the remapping command is accompanied with a series of entries, each of which comprises a plurality of first logical addresses and a plurality of second logical addresses, the method further comprising:
sequentially remapping pages of the second logical area to the first logical area in an order of the series of entries.

7. The method of claim 1, further comprising:
allocating the free block of the second logical area to the first logical area.

8. A memory system comprising:
a nonvolatile memory device including a nonvolatile memory area mapped to a first logical area accessed by a first logical address and a second logical area accessed by a second logical address, wherein the first logical address is converted by a host into the second logical address; and
a controller including a mapping table and configured to change an entry included in the mapping table in response to a remapping command received from the host to remap a page of the second logical area to the first logical area,
wherein the controller copies at least one page of the first logical area to a free block of the second logical area to perform an urgent garbage collection operation.

9. The memory system of claim 8, wherein the controller includes a first register that stores a first number of free blocks included in the first logical area, and the controller performs the urgent garbage collection operation when the number of free blocks is less than a first predetermined number.

10. The memory system of claim 9, wherein the controller includes a second register that stores a second number of free blocks included in the second logical area, and the controller communicates to the host a signal indicating that the second number is less than or equal to a second predetermined number.

11. The memory system of claim 10, wherein the second logical area is mapped to a continuous physical area of the nonvolatile memory area, and the controller includes a third register configured to store a start address of the continuous physical area, and accesses the nonvolatile memory area based on the start address stored in the third register and the second logical address.

12. The memory system of claim 8, wherein the controller communicates an entry including a first logical address of the at least one copied page to the host.

13. The memory system of claim 8, wherein the controller copies a page included in a first block of the first logical area to the free block of the second logical area and allocates the first block as a free block of the first logical area to perform the urgent garbage collection operation.

14. The memory system of claim 8, wherein the nonvolatile memory area comprises a three-dimensional memory array.

15. The memory system of claim 14, wherein the three-dimensional memory array comprises a nonvolatile memory that is monolithically formed in at least one physical level of memory cells having active areas disposed above a silicon substrate.

16. A garbage collection method for a nonvolatile memory device in a memory system including a memory controller, the memory system being operatively connected to a host, wherein a nonvolatile memory area of the nonvolatile memory device is mapped to a first logical area accessed based on a first logical address and a second logical area accessed based on a second logical address, the garbage collection method comprising:
determining to perform an urgent garbage collection operation;
executing the urgent garbage collection operation by copying a page of the first logical area to a free block of the second logical area; and
remapping a page of the second logical area to the first logical area according to an entry accompanying a remapping command received from the host and including the first logical address and second logical address.

17. The method of claim 16, wherein the determining to perform the urgent garbage collection operation is made when a number of free blocks included in the first logical area is less than a predetermined number, or when a number of free blocks included in the first logical area is less than a number of free blocks required to execute a next write operation.

18. The method of claim 17, wherein the performing of the urgent garbage collection operation comprises copying a page included in a first block of the first logical area to the free block of the second logical area and allocating the first block as the free block.

19. The method of claim 16, further comprising:
communicating a signal from the nonvolatile memory device to the host indicating that a number of free blocks of the second logical area is less than or equal to a predetermined number.

20. The method of claim 1, wherein the remapping command is further accompanied by a series of entries, each of which comprises a plurality of first logical addresses and a plurality of second logical addresses, the method further comprising:
sequentially remapping pages of the second logical area to the first logical area in an order of the series of entries.
